(19) United States
(12) Patent Application Publication
(10) Pub. No.: US 2024/0185721 A1
(43) Pub. Date: Jun. 6, 2024

(54) VEHICLE WARNING SYSTEM

(71) Applicant: STELLA CONSULTING SERVICES (PTY) LTD, Zimbali (ZA)

(72) Inventor: Louis James MARAIS, Zimbali (ZA)

(21) Appl. No.: 18/556,498

(22) PCT Filed: Apr. 19, 2022
(86) PCT No.: PCT/IB2022/053650

§ 371 Date: Oct. 20, 2023

(30) Foreign Application Priority Data
Apr. 20, 2021 (ZA) 2021/02596

(51) Int. Cl. G08G 1/16; G01S 7/00; G01S 17/931; G08G 1/01; G08G 1/04

(52) U.S. Cl. CPC G08G 1/166; G01S 7/003; G08G 1/0125; G08G 1/04; G01S 17/931

(57) ABSTRACT

A vehicle warning system is disclosed. The system provides a warning of oncoming traffic to a person positioned at or near a stationary vehicle on a roadway. The vehicle warning system comprises a monitoring component and an alarm component. The monitoring component is configured to detect an oncoming vehicle travelling within a predetermined range of the stationary vehicle on a possible collision course. The alarm component is configured to be communicatively coupled to the monitoring component and spaced apart from the monitoring unit, in use. In response to detection of the oncoming vehicle, a warning signal is sent from the monitoring component to the alarm component and an alarm is activated. The alarm component includes a visual indicator configured to indicate that a communication link between the monitoring component and the alarm component has been established and/or is active.

### FIELD OF THE INVENTION

The invention relates, broadly, to a vehicle warning system. More specifically, the invention relates to a system and method for alerting a person to the approach of possibly hazardous oncoming traffic.

### BACKGROUND TO THE INVENTION

Passive warning reflectors, usually in the form of a reflective triangle, are traditionally placed some distance behind a stationary motor vehicle located on or at the side of a roadway, to warn oncoming traffic of the stationary vehicle up ahead. This can be useful where, for example, a vehicle has broken down or where emergency services are attending to an accident scene.

While these passive warning reflectors are somewhat effective in warning oncoming traffic of possible dangers, they do not provide those persons who may be present at or near the stationary vehicle (e.g. the driver, passengers or breakdown service) with any warning of possible imminent danger in the event of a vehicle disregarding the warning reflector or being unable to avoid the stationary vehicle. If there is a vehicle approaching, a passive warning reflector also does not assist a person in determining whether the vehicle is dangerously close or still far enough away.

More advanced devices for warning roadside work crews of the approach of speeding vehicles are known. Reference can be made, for example, to U.S. Pat. No. 8,237,555 which describes a hazardous vehicle alert system comprising a control module, a special graphic user interface driven by a software package, a speed and distance detector and an alarm module, where the user sets alarm triggers based on reaction time until potential impact from the hazardous vehicle. Reference can also be made, for example, to Australian Patent No. AU 2016266003 which describes an alert system comprising a controller, a vehicle speed sensor configured to generate speed measurements of oncoming vehicles and to communicate said measurements to a controller, a vehicle warning display configured to receive display instructions from the controller and, in response, display a vehicle speed warning, and one or more local alert devices, locatable remotely to the vehicle warning display and configured to receive local alert messages from the controller and make a local alert.

The above devices are rather complex and require a processing unit to compute a number of variables and parameters such as the speed, distance and/or travel time of oncoming vehicles to determine whether a warning must be issued. Another disadvantage is that they may fail to warn the user adequately of a vehicle approaching in a dangerous manner, but at a low speed. Furthermore, these devices may be difficult or cumbersome for individuals to use for their personal vehicles, not only due to their complexity, but also their size, weight and/or number of parts.

In light of the above, a need exists for a simple, yet intelligent system and/or method useful for detecting and immediately warning affected persons of oncoming vehicles travelling in the path of the stationary vehicle regardless of the speed of the oncoming vehicle. A need also exists for such a system in which the user is provided with some form of comfort that the traffic monitoring component is actually functioning while the user is attending or waiting at the stationary vehicle. There further exists a need for such a system that is easy to operate and store.

Embodiments of the invention thus aim to address one or more of the needs identified above, at least to some extent.

### SUMMARY OF THE INVENTION

In accordance with an aspect of the invention, there is provided a vehicle warning system for providing a warning of oncoming traffic to a person positioned at or near a stationary vehicle on a roadway, the vehicle warning system comprising:
a monitoring component configured to detect an oncoming vehicle travelling within a predetermined range of the stationary vehicle and on a possible collision course with the stationary vehicle; and
an alarm component which is configured to be communicatively coupled to the monitoring component and spaced apart from the monitoring unit, in use, wherein the alarm component includes a visual indicator configured to indicate that a communication link between the monitoring component and the alarm component has been established and/or is active,
the monitoring component further being configured to communicate a warning signal wirelessly to the alarm component over the communication link in response to detection of the oncoming vehicle, and
the alarm component further being configured to receive the warning signal from the monitoring component and to activate an alarm in response thereto.

The monitoring component may further be configured to detect, subsequent to the alarm being activated, that the oncoming vehicle is no longer within the predetermined range and/or no longer on the possible collision course with the stationary vehicle, and in response thereto transmit a deactivation signal to the alarm component over the communication link. The alarm component may be configured to receive the deactivation signal and to deactivate the alarm in response thereto.

The monitoring component may include a detection unit which utilises laser or radar detection to detect the oncoming vehicle, in use. For instance, the detection unit may be a “lidar” (“light detection and ranging”) unit. Laser/lidar may be the preferred technique in embodiments of the invention, e.g. due to a laser/lidar detection unit's “detection zone” being relatively specific and direction-oriented, with a relatively narrow beam. In the case of lidar, the oncoming vehicle may be detected/classified as travelling within the predetermined range of the stationary vehicle and on the possible collision course with the stationary vehicle when the oncoming vehicle enters a beam path of the detection unit.

The detection unit may be adjustable so as to adjust a detection distance of the system. Alternatively, the detection distance may be fixed.

The detection distance of the detection unit may be adjustable or pre-selected depending on requirements, but is preferably set/selected at between 300 m and 700 m, and more preferably around 500 m. The detection distance should be selected so as to allow for sufficient warning of occupants of the stationary vehicle and/or person/s attending near the stationary vehicle to take evasive action should it be required.

In embodiments of the invention utilising a laser/lidar detection unit, as alluded to above, the detection unit may have a detection width which is selected/designed so as to be relatively narrow/limited which enables the detection unit to detect only vehicles travelling in or close to the same lane, or other longitudinal zone on the roadway, as the stationary vehicle (usually but not necessarily the emergency lane). This may assist in preventing “false alarms”.

In alternative embodiments, a detection width of the detection unit may be adjusted, selected or limited so as to detect only vehicles travelling in or close to the same lane, or other longitudinal zone on the roadway, as the stationary vehicle. Again this may assist in preventing false alarms.

The monitoring component further comprises a communication module for remotely communicating the warning signal to the alarm component, e.g., via Bluetooth or radio frequency (RF) signals.

The alarm component may include a receiving module for receiving the communicated warning signal from the communication module of the monitoring component, an activating module (or processor) for activating the alarm, and at least one of a visual or audible alarm module. The monitoring component may include both a visual alarm module and an audible alarm module. One or both modules may be triggered when the alarm is activated.

The monitoring component may additionally be configured to warn approaching vehicles of the stationary vehicle, and may include one or more warning lights attached to the monitoring component, which may be activated independently of the monitoring component. Alternatively the warning light/s may be linked to the monitoring component or may form part of the monitoring component, and be configured to be activated upon detection of an approaching vehicle.

In use, the monitoring component is positioned substantially behind the stationary vehicle (along the length of the roadway), i.e. in front of the stationary vehicle from the perspective of oncoming traffic, with the detection unit substantially facing the oncoming traffic, and the alarm component is positioned in close proximity to (i.e. at or near) the stationary vehicle. The alarm component may be positioned on or in the stationary vehicle, but this is not necessary. For instance, the person attending or waiting at the stationary vehicle may position the alarm component close to themselves to ensure that they receive the warning/s.

The term “possible collision course” should be interpreted to mean that the oncoming vehicle is on a course or path that, if unchanged, is likely to lead to a collision between the oncoming vehicle and the stationary vehicle, as determined by the monitoring component. The monitoring component should therefore be positioned such that its detection unit detects vehicles that are likely to collide with the stationary vehicle unless they stop or change their path. The “possible collision course” or “possible collision path” may thus be any path or trajectory of an approaching vehicle that has been detected by the detection unit which has been set up to detect such approaching vehicle, and could effectively be any part of the roadway.

The system may include a location module, e.g. a Global Positioning System (GPS) module, enabling a location of the system to be tracked remotely, in use. The GPS module may be located in the monitoring component or the alarm component, preferably in the alarm component as that component is likely to be closest to the stationary vehicle and/or the relevant person/s, in use.

The monitoring component may include a rechargeable battery (or batteries) which operatively powers the monitoring component. The alarm component may include a rechargeable battery (or batteries) which operatively powers the alarm component.

The system may further include a storage component which is configured to receive the monitoring component and the alarm component for storage when not in use.

The storage component may include storage compartments defined by recesses in a body of the storage component. The storage compartments may be shaped to snugly receive the monitoring component and the alarm component.

The storage component may include an integrated recharging arrangement. The recharging arrangement may be configured such that, when the monitoring component or the alarm component is received in its storage compartment, it is connected to the integrated recharging arrangement.

Preferably, the integrated recharging arrangement includes two sets of electrical connectors such that both the monitoring component and the alarm component can be recharged at the same time, when stored in the storage component.

The connectors may be male connectors and the monitoring component and alarm component may each include a female socket/slot for connecting to a respective male connector.

The integrated recharging arrangement may further include a cable and plug, wherein the plug is configured to be connected to a power supply (e.g. external mains power supply or vehicle power supply) for recharging the battery of the monitoring component and/or alarm component when stored in the storage component.

The monitoring component and/or alarm component may thus be conveniently stored in a “charging position”.

The monitoring component may in some embodiments be configured to be folded and/or disassembled before being inserted into the storage component.

The monitoring component may be connected or connectable to a base, e.g. it may be mounted or mountable to a tripod.

The storage component may further be configured to receive the base. For example, the tripod may be disconnected from the monitoring unit, folded and/or retracted, and stored in a suitable recessed defined in the body of the storage component.

In accordance with another aspect of the invention, there is provided a method of providing a warning of oncoming traffic to a person positioned at or near a stationary vehicle on a roadway, using the vehicle warning system substantially as described above. The method may include the steps of positioning the alarm component at or near the stationary vehicle, positioning the monitoring component substantially behind the stationary vehicle such that the detection unit substantially faces the oncoming traffic, and using the vehicle warning system to detect an oncoming vehicle travelling on a possible collision course of the stationary vehicle and to communicate a warning signal to the alarm component, thereby causing the alarm to be activated to warn the person.

In accordance with another aspect of the invention, there is provided a warning kit which includes at least the monitoring component, the alarm component, and the storage component. The kit may also include a base (for the monitoring unit) such as the tripod referred to above.

### BRIEF DESCRIPTION OF THE DRAWINGS

An exemplary embodiment of the invention is described below by way of example only and with reference to the following drawings, in which:

FIG. 1 is a side view of an embodiment of a vehicle warning system according to the invention, wherein the system includes a monitoring component and an alarm component;

FIG. 2 is a perspective view of the components of the vehicle warning system of FIG. 1;

FIG. 3 is conceptual side view depicting the vehicle warning system of FIG. 1 in use;

FIG. 4 is another conceptual side view, also depicting the vehicle warning system of FIG. 1 in use;

FIG. 5 is a block diagram illustrating some of the logical/functional components of the vehicle warning system of FIG. 1;

FIG. 6 is a perspective view illustrating a storage component which may form part of, or which may be used together with, a vehicle warning system such as the system of FIG. 1; and

FIG. 7 is another perspective view of the storage component of FIG. 6, illustrating the monitoring component and the alarm component of FIG. 1 stored in the storage component.

### DETAILED DESCRIPTION WITH REFERENCE TO THE DRAWINGS

The following description is provided as an enabling teaching of the invention, is illustrative of principles associated with the invention and is not intended to limit the scope of the invention. Changes may be made to the embodiment/s depicted and described, while still attaining results of the present invention and/or without departing from the scope of the invention. Furthermore, it will be understood that some results or advantages of the present invention may be attained by selecting some of the features of the present invention without utilising other features. Accordingly, those skilled in the art will recognise that modifications and adaptations to the present invention may be possible and may even be desirable in certain circumstances, and may form part of the present invention.

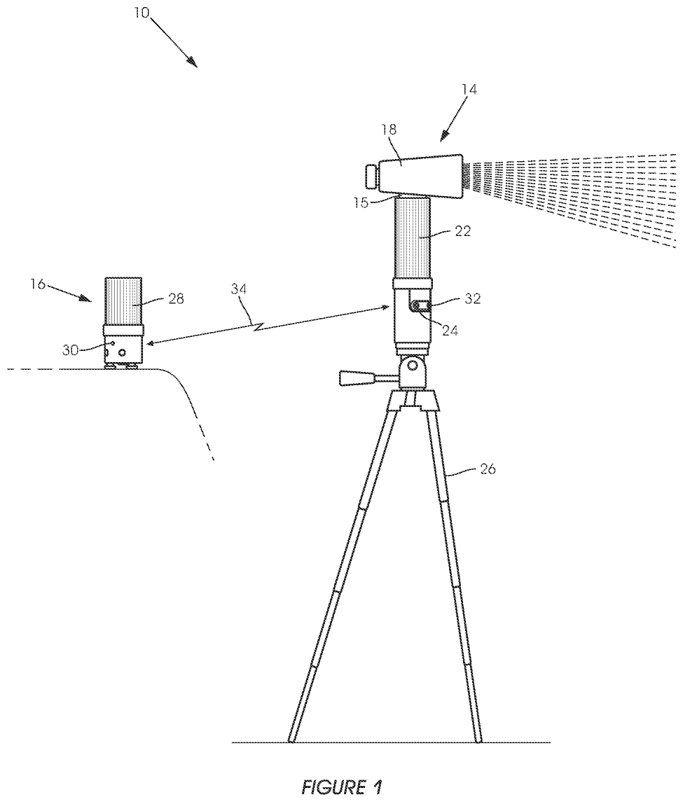

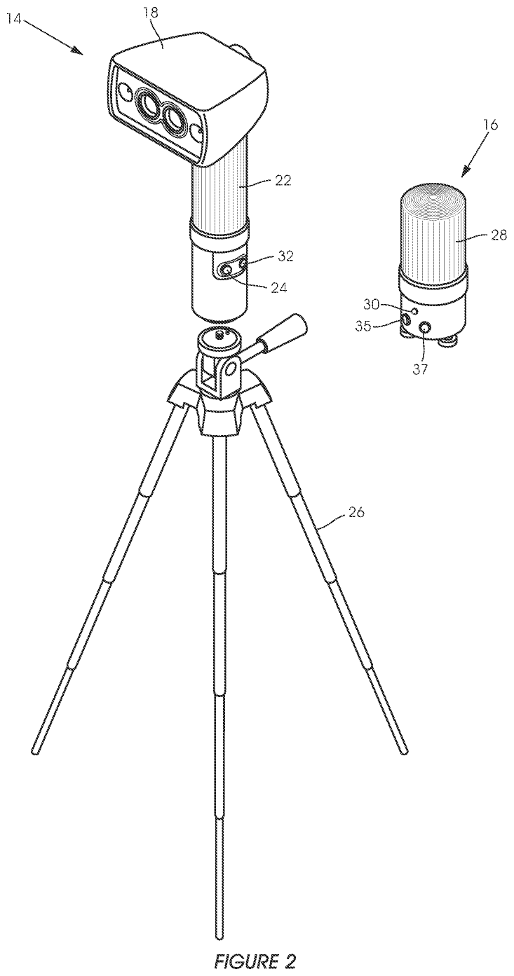

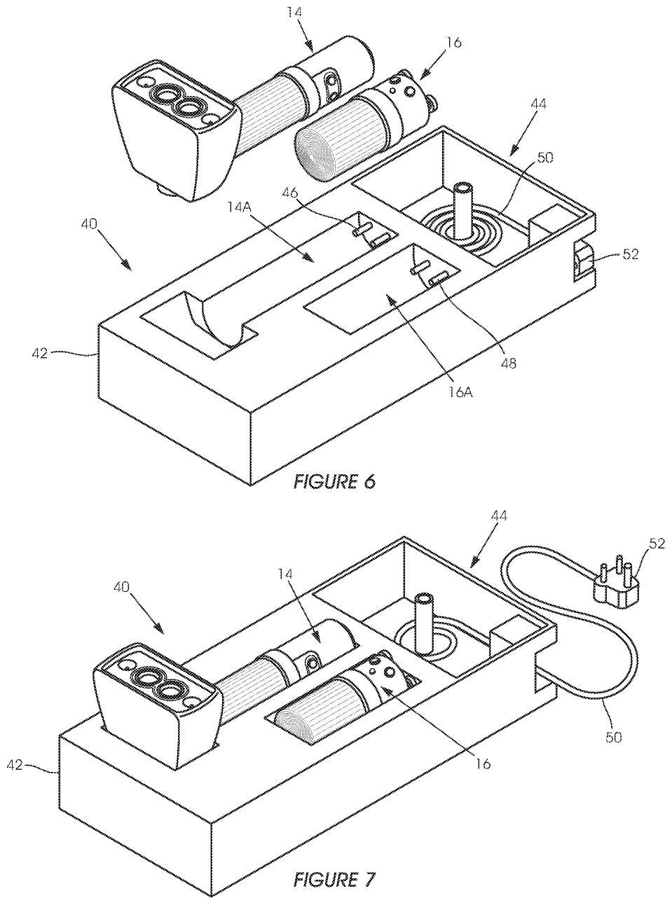

An embodiment of a vehicle warning system (10) is shown in FIGS. 1 to 5 to illustrate an example of the invention. FIGS. 6 and 7 illustrate an example of a storage component (40) which may form part of the system (10) or may be used with the system (10).

The system (10) is used to provide an early warning to a person accompanying a stationary vehicle (12) on a roadway and comprises, as primary components, a monitoring component (14) and an alarm component (16).

The monitoring component (14) comprises a detection unit (18), configured to use lidar technology to detect an approaching vehicle (20) travelling on a possible collision course with the stationary vehicle (12). For instance, a high-performance sensor such as the commercially available “optoNCDT ILR 1191” may be employed. Lidar is used in the preferred embodiment of the invention as the beam can be focused and specifically directed. The detection unit (18) forms the head structure of the monitoring assembly shown in FIGS. 1 to 4 and it will be appreciated that it includes the necessary lidar hardware including a “sighting viewfinder” and “lidar lens”.

The monitoring component (14) further has an internal communication module (19) for remotely and wirelessly communicating a warning signal to the alarm component (16) when an approaching vehicle (e.g. a car), travelling in the same lane as the stationary vehicle and posing a potential hazard to the stationary vehicle, is detected.

The detection range (detection distance) of the detection unit (18) may be adjustable, but is ideally set (or pre-selected) at a distance of around 500 m, while the lidar sensor is specifically selected to have relatively narrow beam, so as only to detect vehicles travelling in or close to the same lane as the stationary vehicle. It will be appreciated that the detection unit (18) must be positioned appropriately in use to ensure that it aligns with the lane or longitudinal zone in which the stationary vehicle is located, or aligns with a possible collision course should a hazardous vehicle or object approach.

In some embodiments, the detection unit (18) may be provided with visual indicating/assisting means to assist the user in positioning the monitoring unit (14) in the correct line or path. For example, in addition to the standard lens of the lidar detection unit (18), which will be well understood by those of ordinary skill in the art, through which the user can look when positioning the monitoring unit (14), a cross or sight may be provided on a top surface of the unit (18) to assist the user with the positioning process.

The detection unit (18) at the top of the monitoring component (14) has connected thereto a warning light arrangement (22) to warn approaching vehicles of the stationary vehicle ahead. The warning light (22) is preferably a flashing light such as a strobe or LED, or a plurality of such lights. High strength or high wattage LEDs may be employed to provide a good warning in use, but should preferably be selected so as not to be too battery-draining.

A light switch (24) enables activation of the light (22) independently of the detection unit (18), such that in certain instances, the monitoring component (14) may be utilised purely as a (passive) warning device for oncoming vehicles. Additional passive warning reflectors may also be included on the monitoring component (14).

In the illustrated embodiment, the monitoring component (14) is removably mounted on a base/stand in the form of a tripod (26), which facilitates steady placement of the monitoring component (14) on the road surface. The tripod (26) also facilitates height adjustment and tilt (pivoting) of the monitoring component (14) where, for example, the monitoring component (14) is positioned on an incline or decline. However, it is to be understood that the monitoring component (14) could be mounted on any suitable base or used without a base. An advantage of the tripod (26) shown in the drawings is that it is easy to take apart, store and/or assemble, easy to pivot the monitoring component (14), and provides a stable base not easily affected by wind or the like.

The head of the assembly, being the detection component (18), is also pivotable about the light (22) at point (15) as indicated in FIG. 1, and thus conveniently adjustable.

Passive warning reflectors may also be added to the base/stand, e.g. the tripod (26) can be fitted with reflective strips making it similar to a passive triangle.

The monitoring component (14) and warning lights (22) attached to it are powered by a suitable rechargeable battery (21). A bottom part (not shown) of the monitoring component (14), i.e. the part that engages the base (26) in use, includes a female electrical socket/slot for receiving a connector of a charger for charging the battery (21), as described further below.

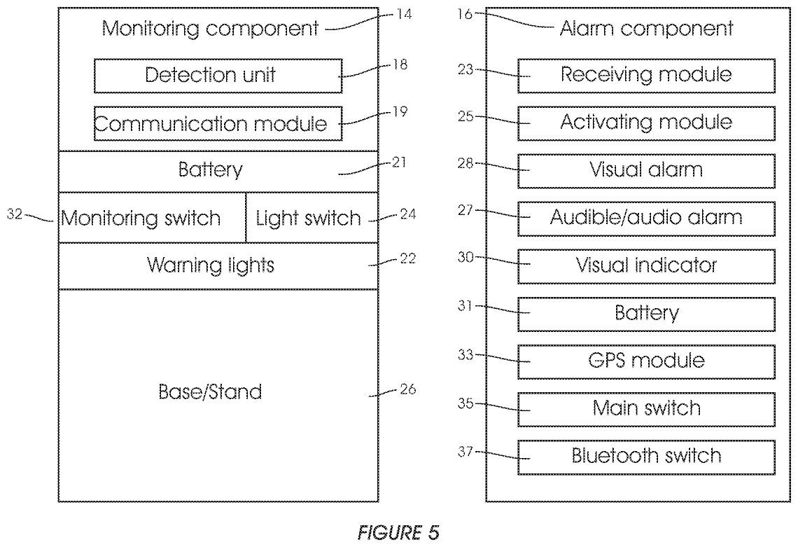

The alarm component (16) comprises a receiving module (23) for receiving a remote warning signal from the monitoring component (14) and a visual (28) and audible/audio alarm (27), activatable on receipt of the remote warning signal. The visual alarm is in the form of a flashing light (28) and the audible alarm (27) is in the form of an integrated speaker (not shown in FIGS. 1 to 4). The alarm component (16) has a processor or activating module (25) which functions to activate and deactivate the alarms (27, 28). The light (28) may be similar to the light or lights (22) described above. The visual alarm module (27) and audible alarm module (28) are also shown in FIG. 5.

A visual indicator (30), in this case in the form of a green LED, on the alarm component (16) provides confirmation that communication with the monitoring component (14) has been established and is active. This provides the user with comfort that the user will be warned of dangerous oncoming traffic, in use. The components (14, 16) wirelessly communicate with each other over a communication link (34) and the visual indicator (30) essentially provides confirmation that the communication link (34) is active. The green LED may, for instance, flash frequently (e.g. more than once per second) when the link (34) is active. In this example embodiment the link (34) is a Bluetooth link, but other communication protocols/means can be employed, e.g. RF.

A suitable processing unit/control circuit/chipset may be included to enable communication, e.g. a “Nordic chipset: nRF52832” in the communication module (19).

When using a suitable Bluetooth link such as Bluetooth 5.0, the components (14, 16) can be positioned up to around 200 metres or even more from each other without breaking the link (34). This may conveniently allow the monitoring component (14) to be placed quite some distance away from the stationary vehicle, in use, to make the system (10) even safer, especially when the vehicle is located in difficult terrain and/or bad weather.

In this embodiment, the alarm component (16) includes two switches (35, 37). The switch (35) is a master switch for turning the alarm component (16) on/off while the switch (37) is a Bluetooth connection switch for establishing the communication link (34) between the components (14, 16). In other embodiments a single switch may integrate these functions.

The alarm component (16) is powered by a suitable rechargeable battery (31). A bottom part (not shown) of the alarm component (16) includes a female electrical socket/slot for receiving a connector of a charger for charging the battery (31), as described further below.

It will be appreciated that one or both of the components (14, 16) may include a user interface or display, providing for instance an indication of remaining battery life and/or communication link (34) status.

In this embodiment, the alarm component (16) further includes a GPS module (33) enabling remote tracking of the alarm component (16). A location of the alarm component (16) may for instance be transmitted to a remote device or server.

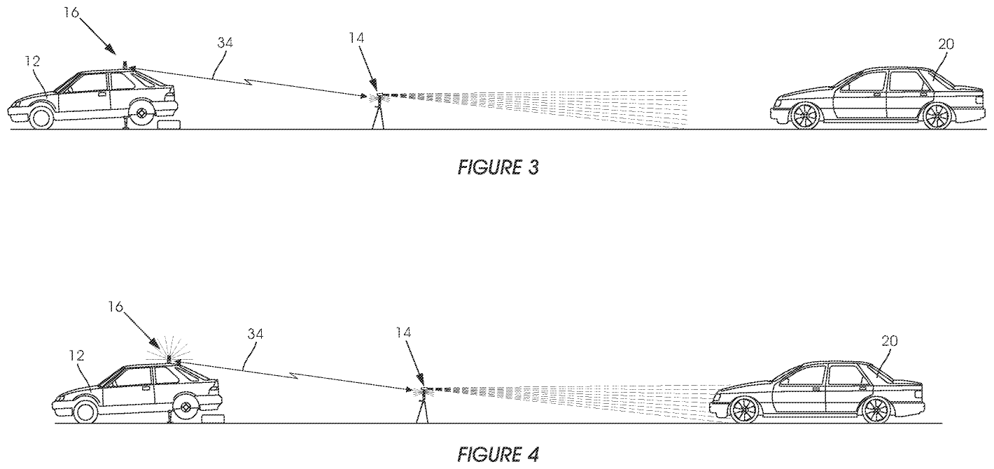

In use and referring to FIG. 3, the monitoring component (14) is positioned a safe distance behind the stationary vehicle (12), facing the oncoming traffic. In this example, the vehicle (12) is being attended to in an emergency lane or shoulder lane of a road.

The alarm component (16) is located in close proximity to the stationary vehicle, such as on the roof of the vehicle. In this example the alarm component (16) is located on the vehicle (12), but it may also be located next to or even inside the vehicle (12).

The detection unit (18) is set up, positioned and adjusted so as to detect any oncoming vehicle (20) travelling on a possible collision course with the stationary vehicle, such as in the same lane as the stationary vehicle, as soon as that oncoming vehicle is within a certain range. It is envisaged that this would be especially useful when the vehicle (12) is in the emergency lane or on the shoulder of the road.

As mentioned above, the detection unit (18) can be set/selected to detect vehicles that are about 400 m, 500 m or even farther away. The detection unit (18) is activated via an activation switch (32) and the wireless communication link (34) between the detection unit (18) of the monitoring component (14) and the alarm component (16) is established, and confirmed by the visual indicator (30) on the alarm component (16).

The warning light (22) on the monitoring component (14) can also be switched on, to provide an early visual warning of the stationary vehicle (12) to traffic.

Referring to FIG. 4, when an oncoming vehicle (20), travelling in or near the same lane or road section as the stationary vehicle (12), moves into the predetermined range of the detection unit (18), in other words into a beam path of the lidar detection unit (18) as shown in FIG. 4, the communication module (19) broadcasts a warning signal to the receiving module (23) of the alarm component (16), which on receipt of the signal activates the visual (28) and audible alarm (27) using the activating module (25), warning anyone near the stationary vehicle of impending danger. This may, for example, allow a person working on or sitting in the vehicle (12) to move clear of the stationary vehicle (12) before the oncoming vehicle (20) reaches the stationary vehicle (12).

As soon as the oncoming vehicle (20) moves outside of the range of the detection unit (18), i.e. out of the beam path of the unit (18) thereby no longer “breaking” the beam, by changing lanes or driving past the detection unit (18), for example, the oncoming vehicle (20) will no longer be detected as a threat by the detection unit (18), the communication module (19) will stop broadcasting the warning signal, and the activating module (25) will deactivate the alarm, causing the visual (28) and audible (27) alarms to be deactivated. The system (10) is thus able to automatically “reset” itself and it is not necessary for a user to reset the alarm after it has been triggered (although a user may manually switch off the alarm component (16) if required).

The inventor believes that the system and method disclosed herein may be highly effective in alerting a user to the approach of possibly hazardous oncoming traffic (irrespective of speed/acceleration). Another advantage may be that the monitoring unit could be used independently, as a conventional warning device, without having to switch on the detection unit, should the user wish to do so. Furthermore, the system may include means indicating to the user that the monitoring component and alarm component are connected, which is an extremely a useful safety feature. The use of a lidar (or other, such as radar-based) detection unit may allow for sufficient range to enable a user to receive the desired early warning. An alarm may be triggered the instant the detection unit's “beam” is broken by an oncoming vehicle. This may prevent accidents such a rear-end collisions and injuries to humans.

In some embodiments of the invention, the monitoring component (14) may further be configured to measure and report on the speed of oncoming vehicles.

It will be appreciated that the monitoring component (14) may be positioned at varying distances from the alarm component (16) (the alarm component typically being at or close to the vehicle (12)), provided the alarm and monitoring components (14, 16) remain in range to keep the communication link active. In use, this distance may be dependent on factors such as terrain and weather conditions. In the event of a blind corner or a blind rise, for example, the monitoring component (14) should be positioned at such a distance and angle relative to the road that the detection unit can monitor any approaching vehicle that could be on a collision path/possible collision course with the stationary vehicle or persons close to the vehicle.

The system (10) may further include a storage component (40), an example of which is illustrated in FIGS. 6 and 7. This component (40) has a dual function in that it allows for both storage and recharging of the components (14, 16) when they are not in use.

The storage component (40) has a polymeric body (42) formed with recesses which define individual storage compartments (14A, 16A). As is best shown in FIG. 6, the storage compartment (14A) is shaped to receive the monitoring component (14) while the storage compartment (16A) is shaped to receive the alarm component (16), both being specifically shaped and dimensioned for a tight/snug and secure fit and storage. In other words the relevant recesses are shaped so as to conform to the contours of the components they are to receive in use. Although not shown in FIGS. 6 and 7, it should be appreciated that the storage component may also define a storage component for the base (e.g. tripod (26)).

It will be appreciated that a suitable cover (not shown) may also be provided to cover the body (42) when the components (14, 16) are stored.

The storage component (40) further has an integrated recharging arrangement (44) located at one end thereof. The recharging arrangement includes two sets of male electrical connectors (46, 48), both connected to an electrical cable (50) which terminates in a plug (52).

FIG. 6 shows the cable (50) and plug (52) in a stowed condition in which the cable (50) is wound around a cylindrical projection defined in the body (42) and located in a recess surrounding the projection. The plug (52) is located at an opening defined in a sidewall of the body (42). FIG. 7 shows the cable (50) and plug (52) in an extended condition for operation, wherein the cable (50) is at least partially unwound and the plug (52) is taken out of the body (42) through the aforementioned opening, so that the plug (52) can be connected to a power supply.

As mentioned above, the bottom of each of the warning system's primary components (14, 16) has a socket for charging. The sockets are configured to receive the electrical connectors (46, 48). When the monitoring component (14) is received in the storage component (40) as shown in FIG. 7, its battery (21) can be charged via the connectors (46). When the alarm component (16) is received in the storage component (40) as shown in FIG. 7, its battery (31) can be charged via the connectors (48). The plug (52) may for instance be connected to a mains power supply or any other suitable power source in use. In some cases the plug (52) may be connected to a power source in a vehicle.

The use of two sets of connectors (46, 48) is advantageous as it allows both components (14, 16) to be recharged at the same time, when stored in the storage component.

In some embodiments, the storage component may be used as a base or platform for positioning the monitoring unit (14). For example, the storage component may have mounting means for mounting the base/tripod of the monitoring unit (14) to the storage component in an upright position. In such embodiments, the storage component may include a weighted bottom so as to ensure that the monitoring unit (14) remains firmly in position and is not, for instance, displaced or toppled by strong winds.

1. A vehicle warning system for providing a warning of oncoming traffic to a person positioned at or near a stationary vehicle on a roadway, the vehicle warning system comprising:
a monitoring component configured to detect an oncoming vehicle travelling within a predetermined range of the stationary vehicle and on a possible collision course with the stationary vehicle; and
an alarm component which is configured to be communicatively coupled to the monitoring component and spaced apart from the monitoring unit, in use, wherein the alarm component includes a visual indicator configured to indicate that a communication link between the monitoring component and the alarm component has been established and/or is active,
the monitoring component further being configured to communicate a warning signal wirelessly to the alarm component over the communication link in response to detection of the oncoming vehicle, and
the alarm component further being configured to receive the warning signal from the monitoring component and to activate an alarm in response thereto.

2. The system according to claim 1, wherein the monitoring component includes a detection unit which operatively utilises lidar detection to detect the oncoming vehicle, wherein the oncoming vehicle is detected as travelling within the predetermined range of the stationary vehicle and on the possible collision course with the stationary vehicle when the oncoming vehicle enters a beam path of the detection unit.

3. The system according to claim 2, wherein the monitoring component is configured to be positioned substantially behind the stationary vehicle and such that the detection unit substantially faces the oncoming traffic.

4. The system according to claim 2, wherein the detection unit is adjustable so as to adjust a detection distance of the system.

5. The system according to claim 1, wherein a detection distance of the system is between about 300 m and about 700 m.

6. The system according to claim 2, wherein the detection unit has a detection width which is selected or limited so as to detect only vehicles travelling in or close to the same lane, or other longitudinal zone in the roadway, as the stationary vehicle.

7. The system according to claim 1, wherein the monitoring component includes a communication module for wirelessly communicating the warning signal to the alarm component over the communication link in response to detection of the oncoming vehicle.

8. The system according to claim 7, wherein the warning signal is communicated by way of Bluetooth or radio frequency (RF) signals.

9. The system according to claim 7, wherein the alarm component includes a receiving module for receiving the communicated warning signal from the communication module of the monitoring component, and an activating module for activating the alarm, and wherein the alarm component further includes one or both of a visual alarm module and an audible alarm module, the visual alarm module and/or audible alarm module being triggered when the alarm is activated.

10. The system according to claim 1, wherein at least one warning light is attached to or forms part of the monitoring component for warning approaching vehicles of the stationary vehicle.

11. The system according to claim 10, wherein the at least one warning light is attached to and configured to be activated independently of the monitoring component.

12. The system according to claim 1, further including a location module which permits a location of the system to be tracked remotely, in use.

13. The system according to claim 1, wherein the monitoring component is further configured to detect, subsequent to the alarm being activated, that the oncoming vehicle is no longer within the predetermined range and/or no longer on the possible collision course with the stationary vehicle, and in response thereto transmit a deactivation signal to the alarm component over the communication link, and wherein the alarm component is further configured to receive the deactivation signal from the monitoring component and to deactivate the alarm in response thereto.

14. The system according to claim 1, wherein the alarm component is configured to be positioned at or near the stationary vehicle.

15. The system according to claim 1, which further includes a storage component configured to receive the monitoring component and the alarm component.

16. The system according to claim 15, wherein the storage component includes storage compartments defined by recesses in a body of the storage component, the storage compartments being shaped to snugly receive the monitoring component and the alarm component.

17. The system according to claim 16, wherein the storage component includes an integrated recharging arrangement.

18. The system according to claim 17, wherein the recharging arrangement includes at least one set of electrical connectors configured such that, when the monitoring component or the alarm component is received in its storage compartment, it is connected to the integrated recharging arrangement via the electrical connectors.

19. The system according to claim 18, wherein the integrated recharging arrangement includes two sets of electrical connectors configured such that both the monitoring component and the alarm component can be recharged at the same time, when stored in the storage component, the electrical connectors being connected to an electrical cable which terminates in a plug.

20. A method of providing a warning of oncoming traffic to a person positioned at or near a stationary vehicle on a roadway, using the vehicle warning system according to claim 14, the method comprising the steps of positioning the alarm component at or near the stationary vehicle, positioning the monitoring component substantially behind the stationary vehicle and such that the detection unit substantially faces the oncoming traffic, and using the vehicle warning system to detect an oncoming vehicle travelling on a possible collision course of the stationary vehicle and to communicate a warning signal to the alarm component, thereby causing the alarm to be activated.
